(19) United States
(12) Patent Application Publication
(10) Pub. No.: US 2018/0245543 A1
(43) Pub. Date: Aug. 30, 2018

(54) Multi-Stage Solid Rocket Motor

(71) Applicant: Alpha Space Test and Research Alliance, LLC, Houston, TX (US)

(72) Inventors: Johnnie P. Engelhardt, West Columbia, TX (US); Robert H. Plunkett, League City, CA (US)

(21) Appl. No.: 15/444,938

(22) Filed: Feb. 28, 2017

(51) Int. Cl. F02K 9/28; F02K 9/34; F02K 9/95

(52) U.S. Cl. CPC F02K 9/28; F02K 9/95; F02K 9/34

(57) ABSTRACT

A multi-stage solid rocket in accordance with this disclosure includes a first or primary solid fuel core that operates as a standard solid rocket. A secondary solid fuel core may be “wrapped around” the primary solid fuel core in a layered arrangement so as to use the same casing. The secondary solid fuel core can be configured with an insufficient amount of oxidizer to burn by itself or to be ignited by the primary solid fuel core during its burn. The oxidizer necessary to enable a secondary solid fuel core burn can be controllably released from a secondary source to permit variable thrust generation. Subsequent cores may be wrapped around prior cores and configured with insufficient amounts of oxidizer to be ignited by any prior core. The oxidizer necessary to enable any subsequent core burn may also be controllably released to permit variable thrust generation.

### BACKGROUND

This disclosure relates generally to rocket motors and rocket motor systems. More particularly, but not by way of limitation, this disclosure relates to a multi-stage solid rocket motor system.

Referring to FIG. 1A, prior art solid rocket motor system 100 includes casing 105 and solid propellant (fuel and oxidizer) 110, combustion chamber 115, exhaust nozzle 120, and igniter system 125. Propellant 110 acts as a solid mass, burning—until complete—in a predictable fashion and producing exhaust gases. Nozzle 120 dimensions are optimized to maintain a specified pressure in combustion chamber 115, while producing thrust from the exhaust gases. More advanced solid rocket motors can be throttled. Yet other known rocket systems may be extinguished and then re-ignited by controlling the nozzle geometry or through the use of vent ports. Referring to FIG. 1B, pulsed rocket motor system 130 includes a number of segments or pulses (135A-135E) separated by barriers (140A-140D). Each segment's burn may be initiated by an igniter (145A-145E) that, once ignited, burn to completion. Barriers 140A-140D are generally destroyed by the burning of the next segment or pulse. As shown, all of the segments or pulses are contained in a single casing (i.e., 105) and use a single combustion chamber (i.e., 115) and nozzle (i.e., 120).

### SUMMARY

In one or more embodiments the disclosed concepts describe a solid rocket that includes a structural casing that encloses a first solid fuel core and one or more secondary solid fuel cores. In one particular embodiment, the rocket system casing includes a first solid fuel core having first fuel and first oxidizer (wherein the first oxidizer is configured to supply sufficient oxygen to sustain combustion of the first fuel) and a second solid fuel core juxtaposed in a layered configuration with the first solid fuel core, the second solid fuel core having second fuel and second oxidizer (wherein the second oxidizer is configured to supply insufficient oxygen to sustain combustion of the second fuel, and wherein the first oxidizer is further configured to provide insufficient oxygen to ignite or sustain combustion of the second solid fuel core). Such rocket systems may also incorporate or include an exhaust nozzle, one or more igniter systems and a second oxygen source separate from, and in fluid communication with, the second solid fuel core. The second oxygen source may be designed to supply sufficient oxygen to, in combination with the second oxidizer, maintain combustion of the second fuel. In some embodiments the second oxygen source comprises a catalyst retained in a first volume, an oxidizer retained in a second volume, and a combining mechanism for combining the catalyst and the oxidizer. In one embodiment the catalyst and oxidizer may be solid. In other embodiments the catalyst and oxidizer may be liquid. The combining mechanism may vary depending on implementation. Mechanical and/or electro-mechanical and/or pneumatic mechanisms may be employed to control movement and mixing of solid catalyst and oxidizers. Valves and blocking plates may be used to control movement and mixing of liquid catalyst and oxidizers. In still other embodiments, any number of cores may be used. In general, the choice of fuel may constrain how much oxygen needs to be supplied by (oxidizer) which, in turn, may constrain which catalysts are suitable.

### BRIEF DESCRIPTION OF THE DRAWINGS

FIGS. 1A and 1B illustrate a prior art solid rocket motor systems.

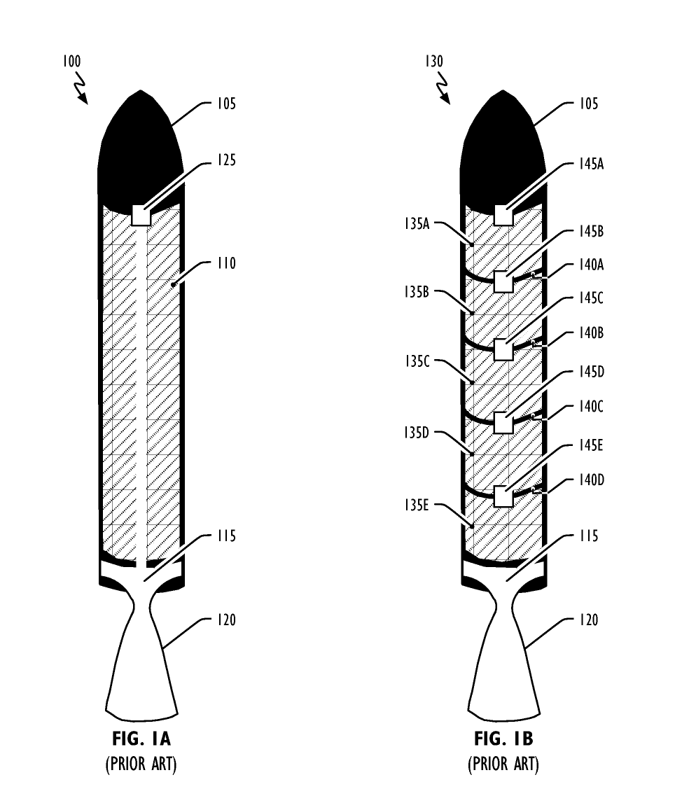

FIGS. 2A-2D show, in block diagram form, a multi-stage solid rocket system in accordance with one embodiment.

FIG. 3 shows another view of the multi-stage rocket system in accordance with FIG. 2.

FIG. 4 shows, in block diagram form, a multi-stage solid rocket system in accordance with another embodiment.

FIG. 5 shows, in block diagram form, another embodiment of a multi-stage rocket system in accordance with this disclosure.

### DETAILED DESCRIPTION

This disclosure pertains to solid rocket motor systems and methods to fabricate and control same. A multi-stage solid rocket in accordance with this disclosure includes a first or primary solid fuel core that operates as a standard solid rocket. A secondary solid fuel core may be “wrapped around” the primary solid fuel core in a layered arrangement so as to use the same casing. The secondary solid fuel core can be configured with an insufficient amount of oxidizer to burn by itself or to be ignited by the primary solid fuel core during its burn. The oxidizer necessary to enable a secondary solid fuel core burn can be controllably released from a secondary source to permit variable thrust generation. Subsequent cores may be wrapped around prior cores and configured with insufficient amounts of oxidizer to be ignited by any prior core. The oxidizer necessary to enable any subsequent core burn may also be controllably released to permit variable thrust generation.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of solid rocket motor systems having the benefit of this disclosure.

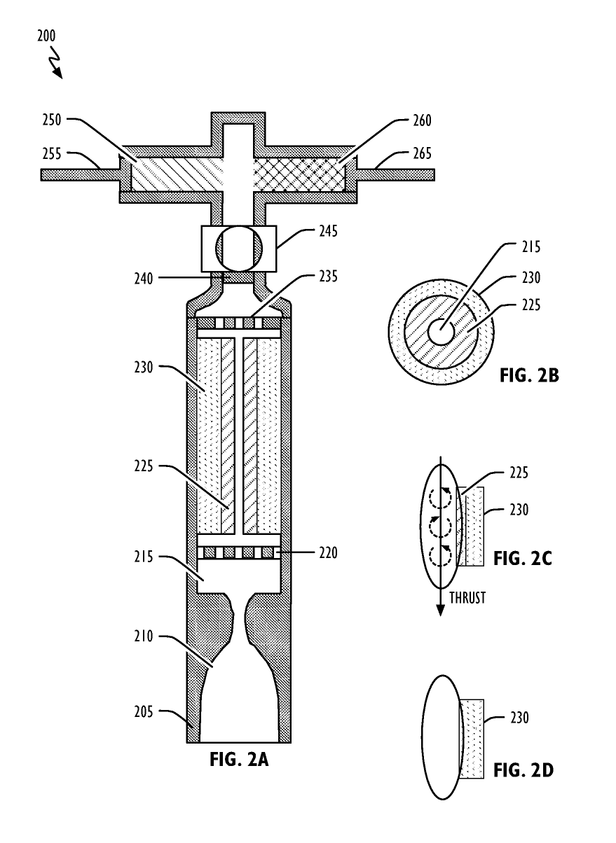

Referring to FIG. 2A, in one or more embodiments multi-stage rocket system 200 can include structural casing 205, exhaust nozzle 210, combustion chamber 215, burn plate 220, primary solid fuel core 225, secondary solid fuel core 230, deflector plate 235, gas barrier 240, valve 245, catalyst 250, catalyst driver 255, oxidizer 260, and oxidizer driver 265. As shown in the illustrated embodiment, multi-stage rocket system 200 utilizes a common infrastructure for both primary and secondary solid fuel core burns (e.g., structural case 205, exhaust nozzle 210, combustion chamber 215 and burn plate 220)—FIG. 2B shows how secondary solid fuel core 230 may wrapped around primary solid fuel core 225 in a laminated fashion. In general, any pattern currently used in solid rocket motor design (e.g., star shapes, squares, slots or rods) may be utilized to control chamber pressure and thrust. Only the secondary solid fuel core (230) and oxidizer provisioning system are different (e.g., elements 235-265).

In one embodiment primary solid fuel core 225 may be ignited via any of a number of different types of igniter systems (not shown in FIG. 2). The function of an igniter is to induce a combustion reaction in a controlled and predictable manner. Solid rocket ignition systems typically include an initiation system, an energy release system, and the hardware for mounting them in or to the rocket motor. Illustrative ignition systems include, but are not limited to, electro-explosive devices (e.g., electrically insulated terminals in contact with, or adjacent to, a composition that reacts chemically when the required energy level is discharged through the terminals), through-bulkhead devices (e.g., employing detonation shock waves), mechanical devices (e.g., percussion primers), lasers, hypergolic systems (e.g., oxidizers such as chlorine trifluoride that react hypergolically on contact with solid rocket propellant), mild detonator trains (e.g., a mixture of detonating and deflagrating charges encased in metal sheaths), and thermo-electric materials (e.g., using heat induced by passing current through a junction of dissimilar materials such as p- and n-type semiconductors). In accordance with this disclosure, gas barrier 240 and valve 245 at the top of combustion chamber 215 are configured to prevent gasses from impinging upon secondary catalyst 250 and oxidizer 260 while primary solid fuel core 225 is burning. By way of example, burn barrier 240 could be an aluminum plate with arc contacts on its upper surface (i.e., towards valve 245). In one or more embodiments, power could be applied to the arc contacts to burn the aluminum plate away while also providing ignition energy to secondary solid fuel core 230 (see discussion below). Burn barrier 240 could also be seals (e.g., one or more O-rings) protected by insulation fashioned from rope seals made of ceramic (carbon) fibers or super-alloy wires such as used in the NASA space shuttle launch system. Valve 245 could be, for example, a needle, ball or plug valve. As will be discussed in below, valve 245 may be used to throttle secondary solid fuel core combustion by controlling the amount of oxidizer 260 (e.g., oxygen) permitted to interact with the surface of secondary solid fuel core 230. In general, gas barrier 240 and valve 245 may be implemented in any manner that achieves the goal of isolating secondary catalyst 250 and oxidizer 260 during primary solid fuel core 225 burn operations.

Referring to FIG. 2C, once ignited primary solid fuel core 225 may be designed to release sufficient oxygen (O) to sustain its burn, but not so much as to ignite secondary solid fuel core 230. Primary solid fuel core propellants include, without limitation, Ballistite and Cordite. Ballistite includes approximately 43% fuel (nitroglycerine), 51.5% oxidizer (nitrocellulose), 1% binding agent (e.g., plasticizer), and 4.5% other material. Cordite includes approximately 28% fuel (nitroglycerine), 56.5% oxidizer (nitrocellulose), 4.5% binding agent (e.g., plasticizer), and 11% other material. Referring to FIG. 2D, secondary solid fuel core 230 may be designed so that it does not release sufficient oxygen to sustain its own burn, or to burn/ignite in the presence of primary solid fuel core combustion, so that once the primary solid fuel core material is consumed, combustion self-terminates.

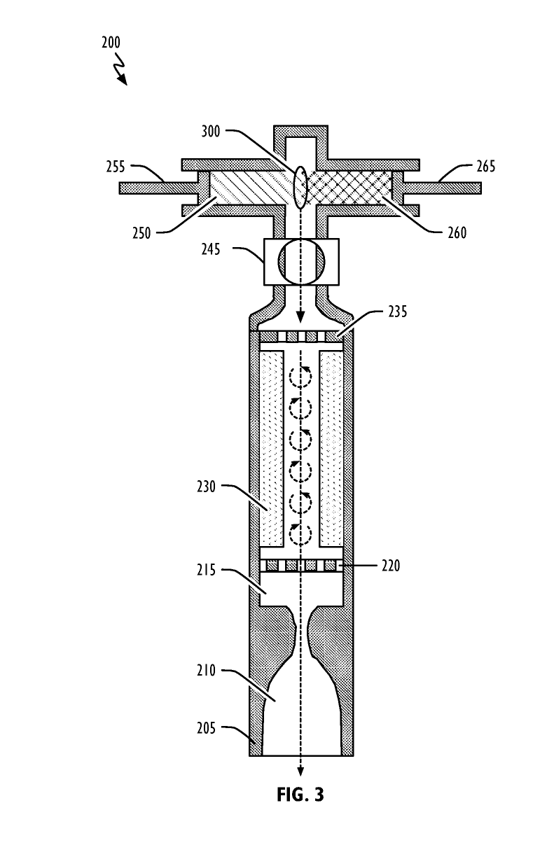

Referring to FIG. 3, after consuming the primary solid fuel core, secondary solid fuel core 230 may be used to generate thrust by removing gas barrier 240 (not shown, see discussion above), opening valve 245, and using driver mechanisms 255 and 265 to force physical contact between secondary catalyst 250 and oxidizer 260 (e.g., stepper motors driving acme screws). In the embodiment shown, secondary catalyst 250 and oxidizer 260 are solid; their precise makeup selected to produce a highly exothermic reaction upon contact with one another and, further, to provide sufficient oxygen to permit secondary solid fuel core combustion. In some embodiments an igniter system may also be needed. In one embodiment, ignition could be provided by the same igniter system used to ignite primary solid fuel core 225. In another embodiment, secondary solid fuel core ignition may be provided by a separate but similar system as that used to ignite primary solid fuel core 225. In still other embodiments, the primary and secondary solid fuel core ignition systems could be separate and operate on different principles (e.g., electro-explosive versus through-bulkhead igniters). Drive systems 255 and 265 may be any electric/electro-mechanical system that provides the necessary motion. In one embodiment, one of catalyst 250 and oxidizer 260 could be stationary; all of the relative motion provided by a single driver. During combustion of secondary solid fuel core 230, valve 245 may be operated to control the combustion rate; providing variable thrust output. Accordingly, secondary solid fuel core combustion may be terminated by using driver mechanisms 255 and 265 to disengage secondary catalyst 250 and oxidizer 260 and closing valve 245.

In one embodiment, primary solid fuel core 225 may be used during vehicle launch operations and second core 230 during orbit adjustments and/or to deorbit the vehicle at the end of its life. The amount of oxygen released by the primary solid fuel core's oxidizer, in such embodiments, should be enough to sustain primary solid fuel core combustion but not so much as to allow secondary solid fuel core 230 to burn. Secondary oxidizer 260 must then be able to supply the oxygen needed to sustain secondary solid fuel core combustion. Secondary catalyst 250 may be chosen to provide sufficient energy—when combined with secondary oxidizer 260—to release the secondary oxidizer's oxygen. Table 1 provides the composition of the primary and secondary solid fuel cores and catalysts for two embodiments.

TABLE 1
Example Core Compositions

| | Primary solid | Secondary solid | Secondary | Secondary |
|---|---|---|---|---|
| | fuel core | fuel core | Catalyst | Oxidizer |
| Fuel | 43% C₃H₅N₃O₉ | 40% C | | |
| | (nitroglycerine) | (shale oil coke) | | |
| | | 40% C₁₂H₂₂O₁₁ | | |
| | | (Sucrose) | | |
| | | 20% C₂₂H₄₈O₂₀ | | |
| | | (Corn Starch) | | |
| Oxidizer | 51.5% HNO₃ | | 95% C₃H₈O₃ | 100% KMnO₄ |
| | (nitrocellulose) | | (Glycerin) | (Potassium |
| | | | Unspecified | Permanganate) |
| | | | Binders | |
| Fuel | 28% C3H5N3O9 | 30% C₆H₁₀O₅ | | |
| | (nitroglycerine) | (Cellulose) | | |
| | | 40% C₁₂H₂₂O₁₁ | | |
| | | (Sucrose) | | |
| | | 30% C₂₂H₄₈O₂₀ | | |
| | | (Corn Starch) | | |
| Oxidizer | 56.5% HNO₃ | | 95% C₃H₈O₃ | 100% Na₃PO₄ |
| | (nitrocellulose) | | (Glycerin) | (Sodium |
| | | | Unspecified | Phosphate) |
| | | | Binders | |

Determination of fuel core layer components may be based upon chemical decomposition of the core with respect to the factors that pertain to combustion. Factors required for examination include the rate of decomposition due to oxygen, rate of decomposition due to pressure, burn wave propagation, and flame temperature. Fuel core selection generally needs to incorporate a sustainable rate of oxidation with respect to the oxygen generated with a typically 10% excess. Fuel core selection should have a stable burn wave propagation to prevent shedding of fuel that can block the nozzle and cause motor failure. Fuel core selection should have an achievable decomposition with respect to temperature of the core and the case material capabilities. In addition, fuel core selection should have stable pressure decomposition properties to prevent pressure spikes that can fracture the case. Taking these factors into account, the fuel core can be achieved by utilizing chemically generated or natural substances that meet these requirements. Processing of the core should also be done in such a way that the core is homogeneous throughout. Oxidizer and catalyst selection should be done in conjunction with the fuel core needs for excess oxidizer to promote core decomposition. The oxidizer should have excess oxygen to provide when the catalyst is chemically reacted. Exothermic reactions generally provide a better source of oxidizer because the gasses are at elevated temperature and the decomposition of the total species within the gasses can be caused to provide more oxygen with a minor increase in temperature that occurs in the combustion chamber of the motor. The entire selection of the core material, oxidizer and catalyst must be tuned to prevent catastrophic detonation of the motor.

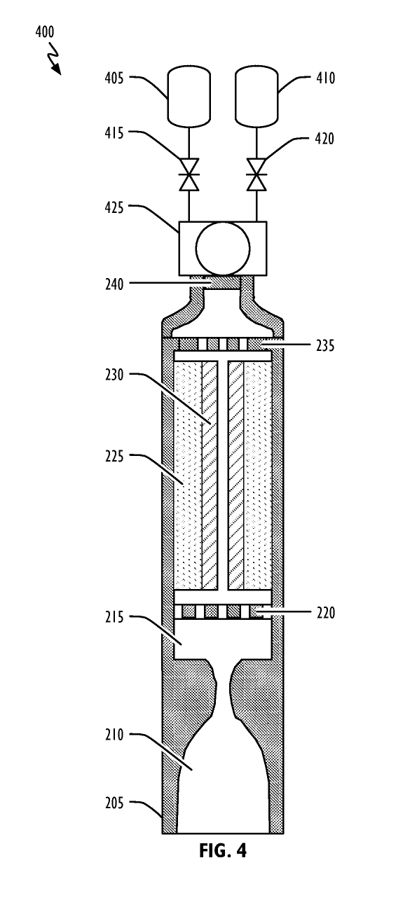

Referring to FIG. 4, multi-stage solid rocket system 400 may utilize liquid secondary catalyst 405 and oxidizer 410 instead of solid formulations such as 250 and 260 (see FIGS. 2 and 3). In this embodiment, valve 415 controls the amount of catalyst 405 entering valve 425 and valve 420 controls the amount of oxidizer entering valve 425. Valve 425 provides a redundant flow control mechanism for catalyst 405 and oxidizer 410. When all valves 415, 420 and 425 as opened, catalyst 405 and oxidizer 410 mix and combust in the top of combustion chamber 215 so as to ignite secondary solid fuel core 230. As noted above, an igniter system may be used to ensure ignition of the secondary catalyst/oxidizer mix.

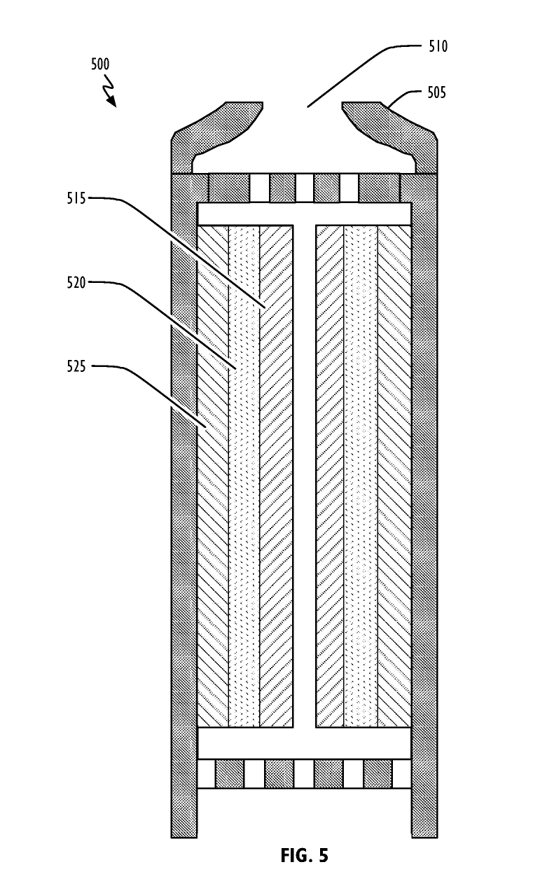

Referring to FIG. 5, multi-stage solid rocket system 500 in accordance with this disclosure may include more than two cores. As shown, casing 505 and combustion chamber 510 enclose three cores: primary solid fuel core 515; secondary solid fuel core 520; and tertiary solid fuel core 525. Any number of cores may be used as long as the following relationships are maintained:

$${( catalyst + oxidizer )}_{i} {\to }^{oxygen} {( core )}_{i} must combust , \\ but {( catalyst + oxidizer )}_{i} {\to }^{oxygen} {( core )}_{i + 1} must not combust ,$$

where is an integer that runs from 1 to n where ‘n’ represents the total number of cores. In general, the choice of fuel—(core)ᵢ and (core)ᵢ₊₁ material—may constrain how much oxygen needs to be supplied by (oxidizer), which, in turn, may constrain which catalysts are suitable. The disclosed systems may include different types of oxidizer systems. For example, liquid and solid, liquid-solid and solid, etc. and may require multiple control valves to apply the oxidizer to the fuel cores.

Referring again to FIGS. 2-4, in addition to the above concerns, multi-stage solid rocket systems in accordance with this disclosure may optimize the design of exhaust nozzle 210 to provide maximum possible thrust for each of the cores. Alternatively, nozzle 210 may be designed to optimize the burn of one core (e.g., primary solid fuel core 225), while providing sufficient efficiency during other core burns (e.g., secondary solid fuel core 230) to meet mission goals. Further, casing 205 should be designed to withstand the thrust and other mechanical stresses induced by each of the core burns.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). By way of example, solid rocket motor systems in accordance with this disclosure may also include a steerable nozzle for guidance, avionics, auxiliary power units (APUs), controllable tactical motors, controllable divert and attitude control motors, and thermal management materials. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A multi-stage solid rocket, comprising:
a structural casing;
a first solid fuel core enclosed in the structural casing and having first fuel and first oxidizer, wherein the first oxidizer is configured to supply sufficient oxygen to sustain combustion of the first fuel;
a second solid fuel core enclosed in the structural casing and in a layered configuration with the first solid fuel core, the second solid fuel core having second fuel and second oxidizer, wherein the second oxidizer is configured to supply insufficient oxygen to sustain combustion of the second fuel, and wherein the first oxidizer is further configured to provide insufficient oxygen to ignite or sustain combustion of the second solid fuel core; and
a second oxygen source separate from, and in fluid communication with, the second solid fuel core, wherein the second oxygen source is configured to supply sufficient oxygen to, in combination with the second oxidizer, maintain combustion of the second fuel.

2. The multi-stage solid rocket of claim 1, further comprising a first igniter system configured to ignite the first solid fuel core.

3. The multi-stage solid rocket of claim 2, further comprising a second igniter system configured to ignite the second oxygen source.

4. The multi-stage solid rocket of claim 3, wherein the first and second igniter systems comprise the same igniter system.

5. The multi-stage solid rocket of claim 1, wherein the second oxygen source comprises:
a catalyst retained in a first volume;
an oxidizer retained in a second volume; and
a combining means for combining the catalyst and the oxidizer.

6. The multi-stage solid rocket of claim 5, wherein:
the catalyst comprises a solid catalyst;
the oxidizer comprises a solid oxidizer; and
the combining means comprises an electro-mechanical system that, when activated, brings the catalyst and oxidizer into physical contact.

7. The multi-stage solid rocket of claim 5, wherein:
the catalyst comprises a liquid catalyst;
the oxidizer comprises a liquid oxidizer; and
the combining means comprises one or more valves that, when jointly activated, bring the catalyst and oxidizer into physical contact.

8. The multi-stage solid rocket of claim 5, wherein the first solid fuel core comprises nitroglycerine and nitrocellulose.

9. The multi-stage solid rocket of claim 8, wherein the second solid fuel core comprises Carbon and Sucrose.

10. The multi-stage solid rocket of claim 9, wherein:
the catalyst comprises Glycerin; and
the oxidizer comprises Potassium Permanganate.

11. The multi-stage solid rocket of claim 1, further comprising a third solid fuel core enclosed in the structural casing and in a layered configuration with the first and second solid fuel cores, the third solid fuel core having third fuel and third oxidizer, wherein:
the third oxidizer is configured to supply insufficient oxygen to sustain combustion of the third fuel; and
the second oxidizer is further configured to supply insufficient oxygen to ignite or sustain combustion of the third solid fuel core.

12. The multi-stage solid rocket of claim 11, further comprising a third oxygen source having:
a third catalyst retained in a third volume;
an third oxidizer retained in a third volume; and
a third combining means for combining the third catalyst and the third oxidizer.

13. A multi-stage solid rocket, comprising:
a structural casing;
a first solid fuel core enclosed in the structural casing and having first fuel and first oxidizer, wherein the first oxidizer is configured to supply sufficient oxygen to sustain combustion of the first fuel; and
a second solid fuel core enclosed in the structural casing and in a layered configuration with the first solid fuel core, the second solid fuel core having second fuel and second oxidizer, wherein the second oxidizer is configured to supply insufficient oxygen to sustain combustion of the second fuel, and wherein the first oxidizer is further configured to provide insufficient oxygen to ignite or sustain combustion of the second solid fuel core.

14. The multi-stage solid rocket of claim 13, further comprising an exhaust nozzle configured to funnel exhaust from combustion of the first and second solid fuel cores.

15. The multi-stage solid rocket of claim 14, further comprising one or more igniter systems.

16. The multi-stage solid rocket of claim 15, wherein a first igniter system is configured to ignite the first solid fuel core.

17. The multi-stage solid rocket of claim 16, wherein a second igniter system is configured to ignite the second solid fuel core.

18. The multi-stage solid rocket of claim 13, further comprising a second oxygen source separate from, and in fluid communication with, the second solid fuel core, wherein the second oxygen source is configured to supply sufficient oxygen to, in combination with the second oxidizer, maintain combustion of the second fuel.

19. The multi-stage solid rocket of claim 18, wherein the second oxygen source comprises:
a catalyst retained in a first volume;
an oxidizer retained in a second volume; and
a combining means for combining the catalyst and the oxidizer.

20. The multi-stage solid rocket of claim 19, wherein:
the catalyst comprises a solid catalyst;
the oxidizer comprises a solid oxidizer; and
the combining means comprises an electro-mechanical system that, when activated, brings the catalyst and oxidizer into physical contact.

21. The multi-stage solid rocket of claim 19, wherein:
the catalyst comprises a liquid catalyst;
the oxidizer comprises a liquid oxidizer; and
the combining means comprises one or more valves that, when jointly activated, bring the catalyst and oxidizer into physical contact.
